(19) United States
(12) Patent Application Publication
(10) Pub. No.: US 2024/0310980 A1
(43) Pub. Date: Sep. 19, 2024

(54) SYSTEM AND METHOD FOR SYNCHRONIZING PROJECT DATA

(71) Applicant: ipQuants AG, Schaffhausen (CH)

(72) Inventors: Tony Afram, Dachsen (CH); Nikolaos Georgiadis, Thessaloniki (GR)

(21) Appl. No.: 18/671,023

(22) Filed: May 22, 2024

Related U.S. Application Data
(63) Continuation of application No. PCT/IB2022/061240, filed on Nov. 21, 2022.
(60) Provisional application No. 63/282,007, filed on Nov. 22, 2021.

(51) Int. Cl. G06F 3/0484; G06F 3/0481

(52) U.S. Cl. CPC G06F 3/0484; G06F 3/0481; G06F 2203/04803

(57) ABSTRACT

Systems and method for synchronizing electronic projects are described. Generally, in the system the electronic project may be displayed on a user interface. The electronic project includes a first project view containing a first project content section and a second project view containing a second project content section. Each of the first project view and second project view is accessible via the user interface. The electronic project may be shared with at least one collaborator via a collaborator interface. The electronic project is then displayed on the collaborator interface such that the first project view is accessible via the collaborator interface and the second project view is inaccessible via the collaborator interface.

### CROSS REFERENCE TO RELATED APPLICATION/INCORPORATION BY REFERENCE STATEMENT

The present patent application is a continuation of the international patent application identified by PCT/IB2022/061240 having an international filing date of Nov. 21, 2022, which claims priority to and incorporates by reference the entire provisional patent application identified by U.S. Ser. No. 63/282,007, filed on Nov. 22, 2021, and claims priority thereto under 35 U.S.C. § 119(e). The entire content of the international patent application identified by PCT/IB2022/061240 and the United States provisional patent application identified by U.S. Ser. No. 63/282,007 is hereby incorporated herein by reference.

### FIELD OF THE DISCLOSURE

The present disclosure relates to methods for reviewing electronic project(s) and systems for reviewing electronic project(s).

### BACKGROUND

User interfaces, such as graphical user interfaces (GUIs), for browsing electronic documents (e.g., web pages, PDF documents) are well known. Such known user interfaces enable a user to review an electronic document by scrolling through the electronic document through user input on a computer system such as a desktop computer device, mobile computer device, and the like.

The scrolling operation allows the user to review different segments of the document, such as the different pages. The scrolling operation is, for example, conducted by keystroke, mouse input or user touch input. The scrolling operation can also be conducted by touchless input, such as touchless user movements, eye-tracking and/or voice command; in case the computing system has such touchless functionality.

When collaborating with one or more users on shared content of an electronic document, a project owner can lock the shared content such that one or more collaborators are solely able to view the shared content. Such settings give the project owner confidence that the collaborator(s), while able to see the content, will not be able to alter it. Under certain circumstances, a project owner may desire non-editable content to be un-viewable by the collaborator(s). For this desire, within existing system in the art, the project owner will need to save a separate electronic file under a separate electronic file name before sharing such “collaborator ready” version of the electronic file. The separate electronic file would then contain the content which the project owner wants to hide from the one or more collaborators.

In another example, if a project owner would like to share several different electronic files (e.g., multiple EXCEL files, EXCEL is ® trademark of Microsoft Inc.), the project owner will need to save a separate electronic file under a separate electronic file name for each excel file before sharing such “collaborator ready” version of the electronic file. The process is then repeated for each electronic file at once.

Such activity is time consuming and resources intensive, causing the project owner to interrupt workflow, and may lead to higher costs for the project owner's organization. Repeatedly creating “collaborator ready” versions for each file also requires more electronic storage capacity and higher energy consumption across computer devices. For example, within the legal industry, multiple “collaborator ready” versions for each file may need to be created as confidential content may exist within each work product. This can result in thousands of electronic documents to be stored in multiple alternative versions every day across a large law firm.

Under certain circumstances a project owner may try to reduce risk in sharing content and instead print individual copies for collaboration. However, such mass printing may cause an exorbitant consumption of paper and result in negative effect(s) on the environment and high consumption of printer toner.

### SUMMARY

Described herein are systems and methods for electronic project review. Generally, one or more systems as described herein may display an electronic project having a first project view and a second project view. The electronic project may be shared with at least one collaborator. The first project view or second project view of the shared electronic project may be displayed to the collaborator such that the collaborator is not aware of the existence of one or more non-shared project views of the shared electronic project.

In some embodiments, an electronic project review method for reviewing an electronic project may include displaying to a project owner at least one project view that comprises two or more project sections. The electronic project may be shared with at least one collaborator such that at least one project view is shared with and displayed to the at least one collaborator. Additionally, project sections may be selectively displayed to the collaborator such that the collaborator is not displayed all of the project sections available to the project owner.

In some embodiments, content within a first project section of a first project view of the shared electronic project may be displayed to the project owner. The same content may be displayed to the one or more collaborators within at least a second project view of the shared project such that the collaborator and the project owner review the content within different project views of the same shared project.

In some embodiments, an electronic project comprises one or more project views. Each project view may be rendered in a browser window or in a desktop UI, for example. Each project view may comprise one or more project sections. The project sections may be rendered as UI panels. The UI panels may be re-arrangeable and/or re-sizeable panels within the project view. The user may be able to add multiple project section panels inside of one view and project section panels may also be configured to be stacked.

Project section panels may be configured to hold documents as content, and may also be adapted to load other content such as productivity enhancing tools, e.g. a search engine or any other content. Thus, electronic project may be configured to provide for the combination of different project section panels with different content within one and the same project view.

In some embodiments, one or more project sections may load and/or display different content formats (e.g., written, video, audio). For example, written format may include PDF file(s), WORD file(s), EXCEL file(s), PowerPoint file(s) (WORD, EXCEL and PowerPoint are trademarks of Microsoft), for example. In some embodiments, one or more project sections may load and/or display productivity enhancing tools, such as search tools that can be used to conduct keyword search within one or more documents. In some embodiments, multiple project sections of different content formats may be combined, such as content displaying project section and project sections including productivity enhancing tools.

In some embodiments, a project owner may define different collaborator rights for each project view and/or for each project section. For example, if a shared electronic project includes two project views, the project owner can define that the collaborator has editing rights on a first project view, and only viewer rights on a second project view. In addition, or instead, collaborator rights may be defined by project section(s), such that within a first project view, the collaborator may be able to edit content loaded within a first project panel. Within the same project view, the collaborator may be able to edit content loaded in a first project section panel and have an un-editable view of content in a second projection section panel arranged within the same project view. As such, the collaborator is able to view documents side-by-side and have the electronic shared document includes security that the content is solely altered by the project owner.

### BRIEF DESCRIPTION OF THE DRAWINGS

Several embodiments of the present disclosure are hereby illustrated in the appended drawings. It is to be noted that the appended drawings only illustrate several typical embodiments, and are therefore not intended to be considered limiting of the scope of the present disclosure. Further, in the appended drawings, like or identical reference numerals or letters may be used to identify common or similar elements and not all such elements may be so numbered. The figures are not necessarily to scale and certain features and views of the figures may be shown as exaggerated in scale or in schematic in the interest of clarity and conciseness.

FIG. 1 shows a schematic representation of an exemplary embodiment of a synchronizing system in accordance with the present disclosure.

FIG. 2 is a screen shot of an exemplary user interface for reviewing an electronic project comprising project sections in accordance with an embodiment of the disclosure.

FIG. 3 is a screen shot of the exemplary user interface for the project owner shown in FIG. 2, having a sharing manager displayed within a project view of the electronic project.

FIG. 4 is a screen shot of the exemplary user interface shown in FIGS. 2-3, having a selection menu configured for selecting project views to be shared.

FIG. 5 is a screen shot of the exemplary user interface shown in FIG. 4, having sharing settings provided after selecting a desired project view to be shared and defining the collaborator and collaborator type.

FIG. 6 is a screen shot of an exemplary user interface for a collaborator illustrating a project view of an electronic project shared by a project owner.

FIG. 7 is a screen shot of another exemplary user interface for a collaborator illustrating a project view of an electronic project shared by a project owner.

FIGS. 8a and 8b illustrate screen shots of an exemplary shared electronic project.

FIG. 9 is a screen shot of another exemplary user interface for a collaborator wherein the collaborator only has access to one project view and having a corresponding project view tab.

FIG. 10 is a screen shot of another exemplary user interface for a project owner. The user interface includes an exemplary electronic project loaded in browser tab. The exemplary electronic project includes three project views as indicated by the three view tabs, respectively, and project view is open and viewed by the user.

FIG. 11 is a screen shot of the electronic project depicted in FIG. 10, wherein a written format document (PDF document) is loaded in a first project content section, and arranged in a first manner and positioned next to a second project content section.

FIG. 12 illustrates a screen shot of a user interface for a collaborator having one project view available with only one project view tab.

FIG. 13 illustrates a schematic diagram of an exemplary data structure of an electronic project database for implementing sharing and permission settings in accordance with the present disclosure.

### DETAILED DESCRIPTION OF THE EMBODIMENTS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the scope of the disclosure.

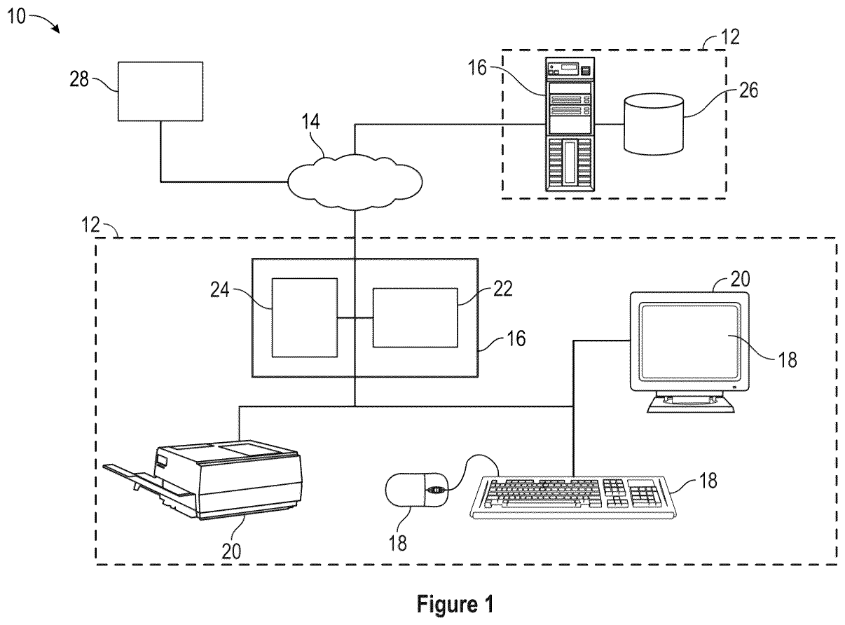

Referring to the Figures, and in particular FIG. 1, illustrated there is a synchronization system 10 for electronic project review in accordance with the present disclosure. Generally and as further described herein, the synchronization system 10 comprises a user interface via configured to provide review and sharing of an electronic project. Additionally, the synchronization system 10 comprises a collaborator user interface for receiving the shared electronic project. In some embodiments, the synchronization system 10 may be configured to display a first project view of the electronic project. The first project view may contain first data and comprise at least one project section. Additionally, at least one further project view may be displayed containing second data and comprising at least one project section. The electronic project may be shared with at least one collaborator via the collaborator interface. The first and second project views of the shared electronic project may be displayed to the collaborator such that the collaborator is not aware of the existence of one or more non-shared project views of the shared electronic project.

Referring to FIG. 1, the synchronization system 10 includes one or more processors 12. The one or more processors 12 may work to execute processor executable code. The one or more processors 12 may be implemented as a single or plurality of processors working together or independently to execute the logic as described herein. Exemplary embodiments of the one or more processors 12 may include, but are not limited to, a digital signal processor (DSP), a central processing unit (CPU), a field programmable gate array (FPGA), a microprocessor, a multi-core processor, and/or combinations thereof, for example. In some embodiments, the one or more processors 12 may be incorporated into a smart device. The one or more processors 12 may be capable of communicating via a network 14 or a separate network (e.g., analog, digital, optical and/or the like). It is to be understood, that in certain non-limiting embodiments, using more than one processor, the processors 12 may be located remotely from one another, in the same location, or comprising a unitary multi-core processor. In some non-limiting embodiments, the one or more processors 12 may be partially or completely network-based or cloud-based, and may or may not be located in a single physical location.

In some non-limiting embodiments, the one or more processors 12 may transmit and/or receive data via the network 14. The network 14 may be implemented as a wireless network, a local area network (LAN), a wide area network (WAN), a metropolitan network, a cellular network, a Global System of Mobile Communication (GSM) network, a code division multiple access (CDMA) network, a 4G network, a 5G network, a satellite network, a radio network, an optical network, an Ethernet network, combinations thereof, and/or the like. Additionally, the network 14 may use a variety of network protocols to permit bi-directional interface and/or communication of data and/or information. It is conceivable that in the near future, embodiments of the present disclosure may use more advanced networking topologies. In some non-limiting embodiments, the network 14 may transmit and/or receive data via the network 14 to and/or from one or more external system (e.g., one or more external computer systems, one or more machine learning applications, artificial intelligence, cloud based system, microphones). In some non-limiting embodiments, the one or more processors 12 may be provided on a cloud cluster (i.e., a group of nodes hosted on virtual machines and connected within a virtual private cloud).

In some non-limiting embodiments, the one or more processors 12 may include one or more input devices 18 and one or more output devices 20. The one or more input devices 18 may be configured to receive information from a user, processor(s), and/or environment, and transmit such information to the one or more processors 12 and/or the network 14. The one or more input devices 18 may include, but are not limited to, implementation as a keyboard, touchscreen, mouse, trackball, microphone, fingerprint reader, infrared port, slide-out keyboard, flip-out keyboard, smart phone, cell phone, remote control, network interface, speech recognition device, gesture recognition device, combinations thereof, and/or the like.

The one or more output devices 20 may be configured to provide data in a form perceivable to a user and/or processors. The one or more output devices 20 may include, but are not limited to, implementations as a monitor, a screen, a touchscreen, a speaker, a website, a television set, a smart phone, a cell phone, a printer, a laptop computer, an optical head-mounted display, combinations thereof, and/or the like. In some non-limiting embodiments, the one or more input devices 18 and the one or more output devices 20 may be implemented as a single device, such as, for example, a touchscreen or tablet.

The one or more processors 12 may be configured to read and/or execute processor executable code and/or configured to create, manipulate, retrieve, alter and/or store data structure into one or more memories 16. In some embodiments, the one or more processors 12 may include one or more memories 16. The one or more processors 12 may include one or more non-transient memory comprising processor executable code and/or software application(s). In some non-limiting embodiments, the one or more memories 16 may be located at the same physical location as the processor 12. Alternatively, one or more memories 16 may be located at a different physical location as the processor 12 and communicate with the processor 12 via a network, such as the network 14. Additionally, one or more memories 16 may be implemented as a “cloud memory” (i.e., one or more memories may be partially or completely based on or accessed using a network, such as the network 14). The one or more memories 16 may store processor executable code and/or information comprising one or more database 22 and program logic 24 (i.e., computer executable logic). In some non-limiting embodiments, the processor executable code may be stored as a data structure, such as a database and/or data table, for example. In use, the one or more processor 12 may execute the program logic 24 controlling the reading, manipulation and/or storing of data as detailed in the methods described herein. In some embodiments, at least one database 22 may include a project database.

Facilitation of review of at least one electronic project and/or associated project content section as described herein may be provided via a search system 26. In some embodiments, the search system 26 may be included within the one or more processors 12. In some embodiments, the search system 26 may include a separate processor and a separate non-transitory computer readable medium 16, linked by way of high speed bus. The processor and the non-transitory computer readable medium of the search system 26 may be implemented in a similar manner as the one or more processor 12 and the non-transitory computer readable medium 16 described herein.

In some embodiments, a user may query the search system 26 for one or more electronic project(s) and/or associated project content sections as described herein. In some embodiments, the electronic project may be a project that enables review of one or more documents configured to be retrieved from the database 22 (e.g., project database), following a search in the search system 26. Alternatively, in some embodiments, the electronic project may be obtained from an external source 28.

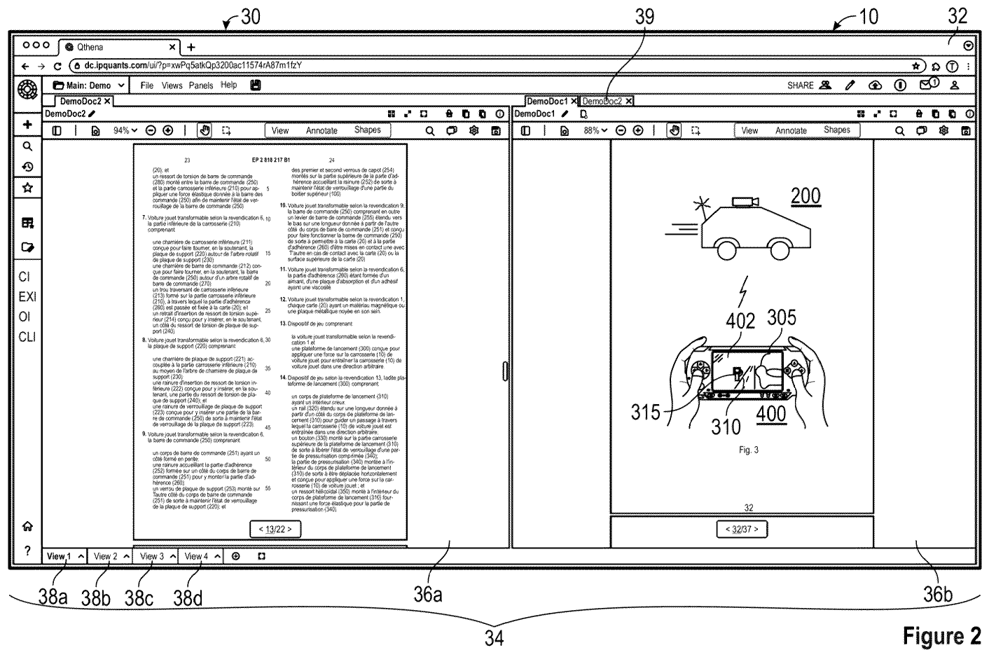

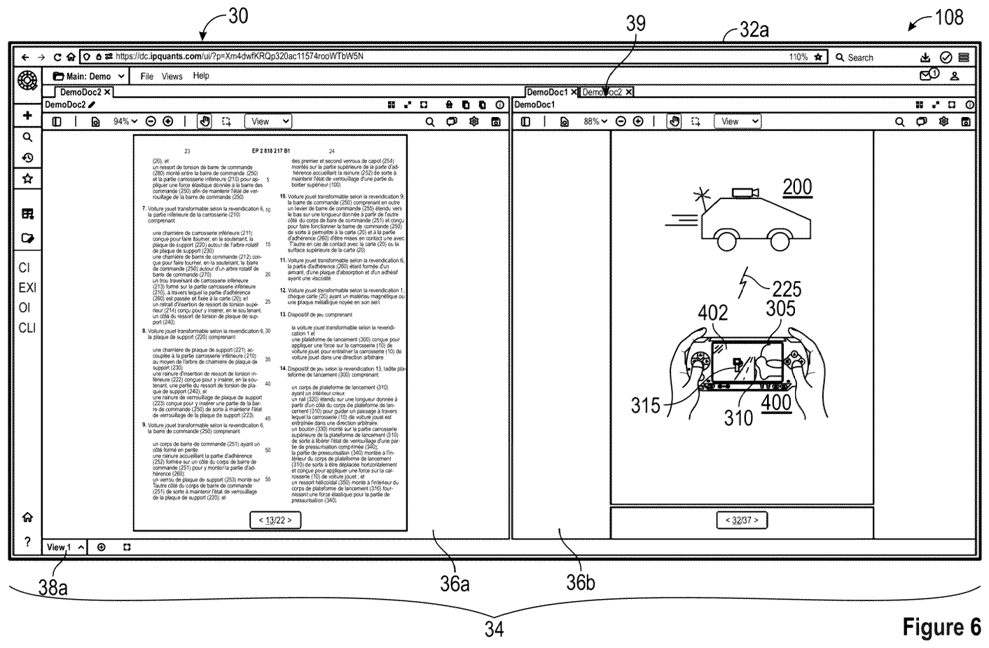

Referring to FIGS. 1 and 2, the synchronization system 10 is configured to provide review of an electronic project 30 via a user interface 32, and collaborator interface 32a (shown in FIG. 6). The user interface 32 and collaborator interface 32a may be provided via program logic 24 and controllable via the one or more processors 12 by way of input devices 18. In some embodiments, the user interface 32 and collaborator interface 32a may be accessible via multiple processors 12 such that a plurality of users (e.g., project owner, collaborators) may access the user interface 32 and collaborator interface 32a. In some non-limiting embodiments, the user interface 32 and collaborator interface 32a may be provided via the network 14. In one example, the user interface 32 and collaborator interface 32a may be provided via Internet access to a server computer arranged to serve pages forming part of the user interface 32 and collaborator interface 32a. In another example, the user interface 32 and collaborator interface 32a may be configured via one or more software packages stored locally on a computer and/or processor 12. In some non-limiting embodiments, the synchronization system 10 may enable access to the electronic project simultaneously via multiple devices as described in further detail herein.

In some embodiments, at least one user of the synchronization system 10 may be a project owner capable of editing, manipulating and/or viewing all portions of the electronic project. Additional users of the synchronization system 10 may include one or more collaborators capable of editing, manipulating and/or viewing select portions of the electronic project.

Generally, the synchronization system 10 may be configured to host one or more electronic projects 30. FIG. 2 is a screen shot 100 of an exemplary user interface 32 for the project owner of the electronic project 30 and is configured to be edited, manipulated and/or viewed by one or more users via the synchronization system 10. For example, the user interface 32 may be configured to be edited, manipulated and/or viewed by the project owner. The user interface 32 of the electronic project 30 may include one or more project views 34. Each project view 34 may be configured to display data, including, but not limited to, content to be reviewed by the project owner.

Each project view 34 may include one or more project content sections 36. For example, in FIG. 2, the project view 34 includes three project content sections 36a, 36b and 36c. Each project view 34 is selectable by project view tab 38. In some embodiments, one or more project content sections 36 may load and/or display different content formats (e.g., written, video, audio). For example, written format may include PDF file(s), WORD file(s), EXCEL file(s), PowerPoint file(s) (WORD, EXCEL and PowerPoint are trademarks of Microsoft), for example. In FIG. 2, project content section 36a is configured to display DemoDoc2, and project section 36b is configured to display DemoDoc DI. In some embodiments, one or more project content sections 36 may load and/or display productivity enhancing tools, such as search tools that can be used to conduct keyword search within one or more documents. In some embodiments, multiple project content sections 36 of different content formats may be combined, such as textual display project content section(s) 36 and project content section(s) 36 including productivity enhancing tools.

Each project content section 36 may be arrangeable and sizable as determined by the user. For example, in FIG. 2, the project section 36c (not fully shown in FIG. 2) is positioned behind project section 36b such that content of the project section 36c is not visible. However, project section 36c is accessible via tab 39.

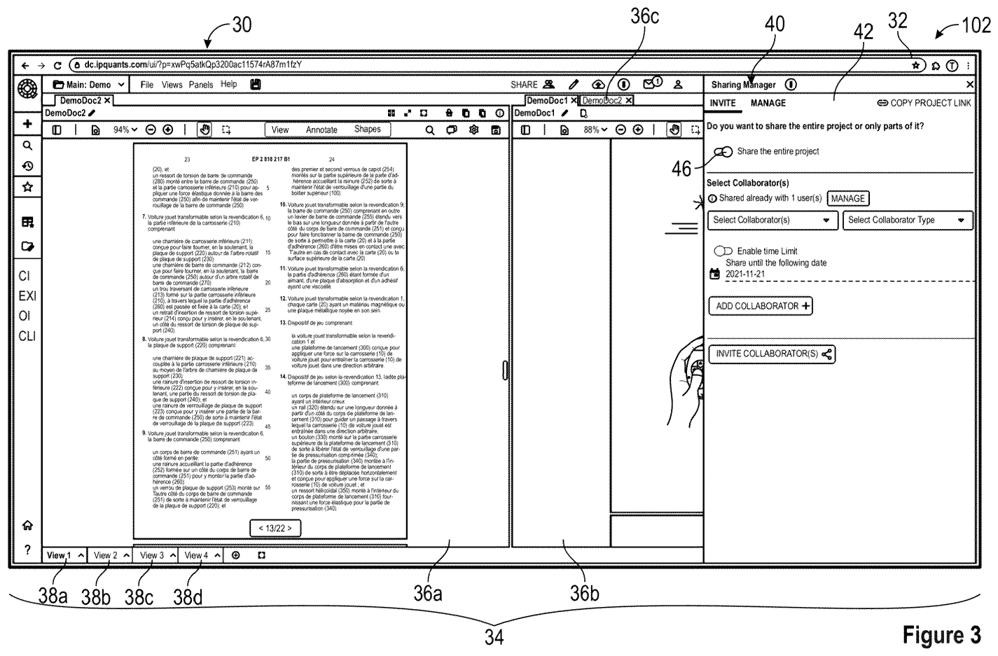

Referring to FIGS. 1 and 3, the synchronization system 10 is configured to provide the electronic project 30 to the project owner and one or more collaborators. In particular, the project owner is capable of defining one or more sharing settings via a sharing manager 40 prior to and/or subsequent to providing the electronic project 30 to the one or more collaborators.

FIG. 3 is a screen shot 102 of an interface panel 42 of the sharing manager 40. The interface panel 42 may include one or more sharing setting options (e.g., add collaborator, invite collaborator, select collaborator type). Sharing setting options may provide for selection of one or more portions of the electronic project 30 to be viewed by one or more collaborators. For example, the project owner may select to share with the one or more collaborators one or more project views 34 or the entire electronic project 30. In FIG. 3, selecting to share the entire electronic project 30 includes four project views 34 accessible via project view tabs 38a-38d, respectively. Alternatively, the selection to share may be with only one or two project views 34. In some embodiments, the project owner may toggle switch 46 to initiate sharing of one or more project views 34.

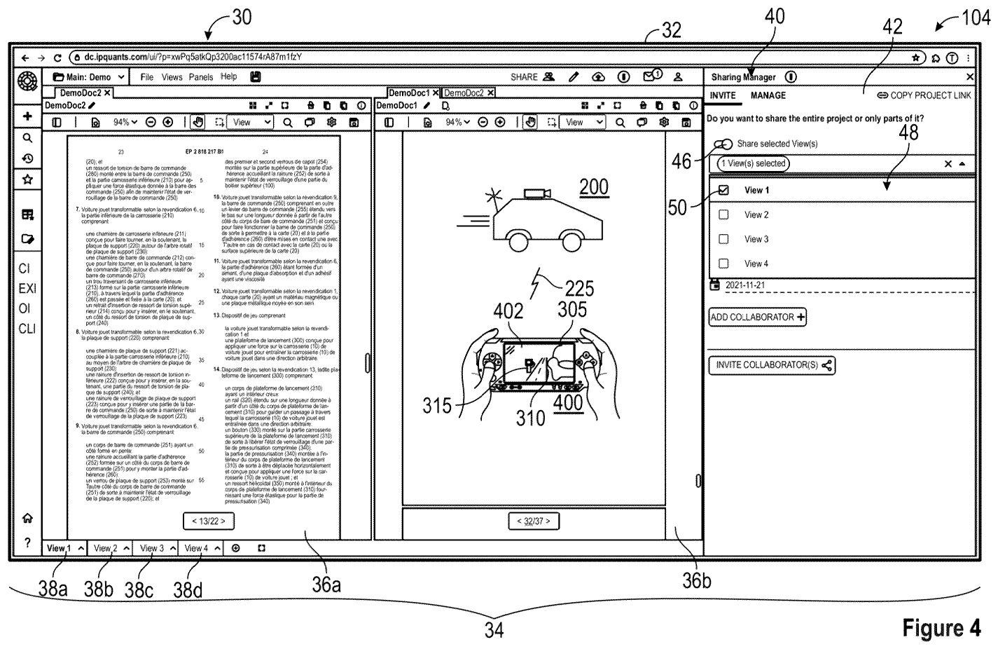

FIG. 4 is a screen shot 104 of the user interface 32 for the project owner illustrating the interface panel 42 wherein the user is able to select one or more project views 34 via a menu 48 to be shared with one or more collaborators. In FIG. 4, “View 1” is selected by ticking the tick box 50. To that end, “View 1” may provide that project view 34 is to be shared with one or more collaborators.

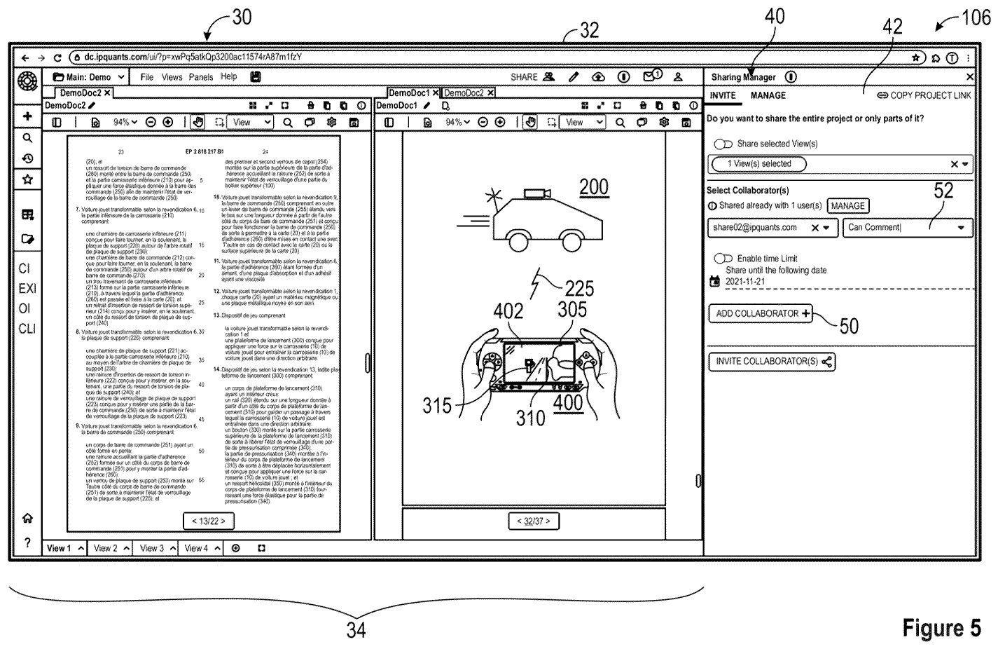

FIG. 5 is a screen shot 106 of the user interface 32 illustrating the interface panel 42 wherein the user is able to select, add and/or invite each collaborator via tick box 50 and/or define one or more collaborator types via button 52. To that end, each project view 34 selected may be shared with each collaborator and/or collaborator type selected. For example, in FIG. 5, the first project view 34 of the electronic project 30 is shared with the collaborator share02@ipQuants.com. The remaining project views 34 of the electronic project 30 remain hidden and/or inaccessible (i.e., non-shareable) to the collaborator share02@ipQuants.com.

FIG. 6 is a screen shot 108 of the user interface 32a of the collaborator share02@ipQuants.com. The user interface 32a of the collaborator may be referred to herein as the collaborator interface 32a. As shown, the first project view 34 is in view and accessible to the collaborator. The remaining project views 34 of the electronic project 30 are hidden and inaccessible to the collaborator. As shown in FIG. 6, the user interface 32a for the collaborator is similar to the user interface 32 of the project manager. The user interface 32a includes access to the project view 34 having project content sections 36a-36c. However, the user interface 32a does not include access to the additional project views 34 accessible via project view tabs 38b-38d as shown in FIG. 2. As such, multiple project views 34 are inaccessible and hidden in the user interface 32a. In particular, and as shown in FIGS. 3-5, the collaborator only has access to the project view “View 1”. That is, the synchronization system 10 (shown in FIG. 1) does not render in the user interface 32a of the collaborator any of the other project view tabs 38b-38d of the electronic project 30. It should be noted that the project view 34 is not a separate file, in that the electronic project 30 is a singular file with multiple portions configured to be selectively shared for viewing, editing and manipulating. Thus, only a portion of the electronic project 30 may be available to one or more collaborators in such a manner that the collaborator may not be aware content viewable within the electronic project 30 may be only a portion of content of the electronic project 30.

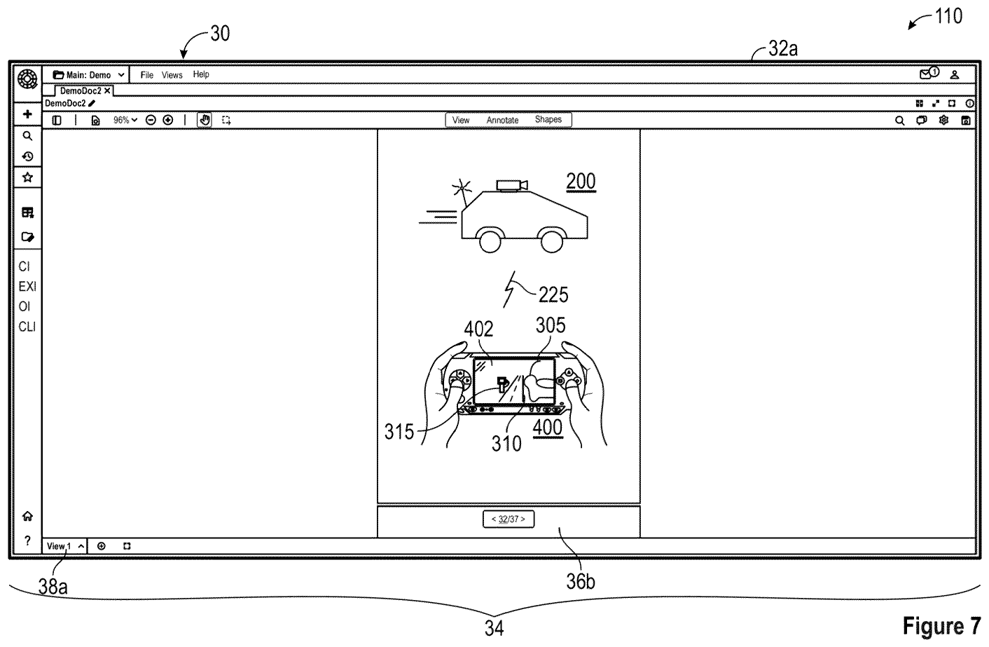

FIG. 7 is a screen shot 110 of the user interface 32a of the collaborator wherein the user, via the sharing manager 40 as described and illustrated in FIGS. 3-5, defines sharing settings of the project content sections 36 of the project view 34. In the example illustrated in FIG. 7, the project section 36b is solely provided to the collaborator in the project view 34 while any additional project sections (e.g., 36a and 36c shown in FIGS. 3-5) remain hidden and inaccessible within the user interface 32a. The rendering of the project view 34 within the user interface 32a shown in FIG. 7, gives the collaborator the impression that only the project view 34 includes one single project content section 36. The project view 34 shown in the user interface 32 of the project owner would still include project content sections 36a and 36c as shown in FIG. 2. The collaborator, however, is not aware of the hidden and inaccessible project views 34 and/or project content section(s) 36.

The project owner may be able to control each project view 34 and/or project content section(s) 36 of the electronic project 30. The sharing manager 40 (shown in FIGS. 3-6) is configured to provide the project owner control of editing, manipulating and/or viewing of each project view 34 and project content section 36 of the electronic project 30 such that the collaborator(s) may only have portions of the electronic project viewable and/or editable. The collaborator(s) may thus be undistracted by visible content to which the collaborator(s) have no access. To that end, portions of data within the electronic project 30 may be kept confidential (e.g., hidden), yet content of the electronic project 30 may be shared with the collaborator with immediate start of the review from the position of the content, such as a particular page the collaborator intends. The collaborator remains undistracted by non-accessible content.

In one non-limiting example, the synchronization system 10 may be a secure sharing platform used for legal purposes wherein attorneys, as the project owner, may communicate with clients, as collaborators. The attorney may determine to selectively share a first project view 34 having first project content section 36 of the electronic project 30 without distracting the client with data deemed irrelevant by the attorney. Additionally, the attorney may selectively share with opposing counsel a second project view 34 having second project content section 36 of the same electronic project 30 without providing the opposing counsel data deemed confidential by the attorney. The first project view may be different than the second project view. Additionally, the first project content section 36 may be different than the second project content section 36.

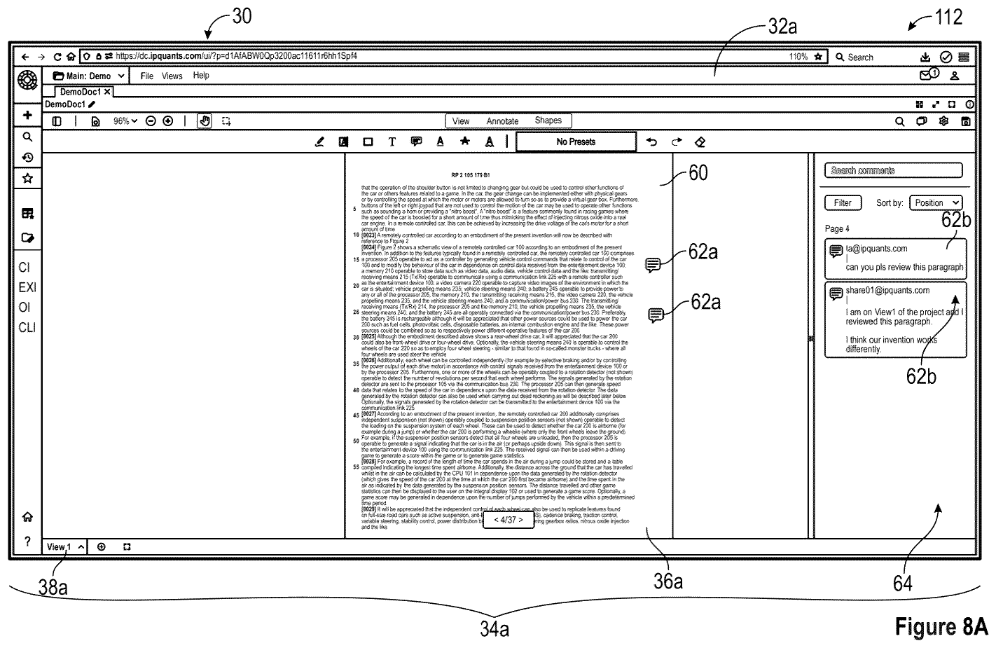

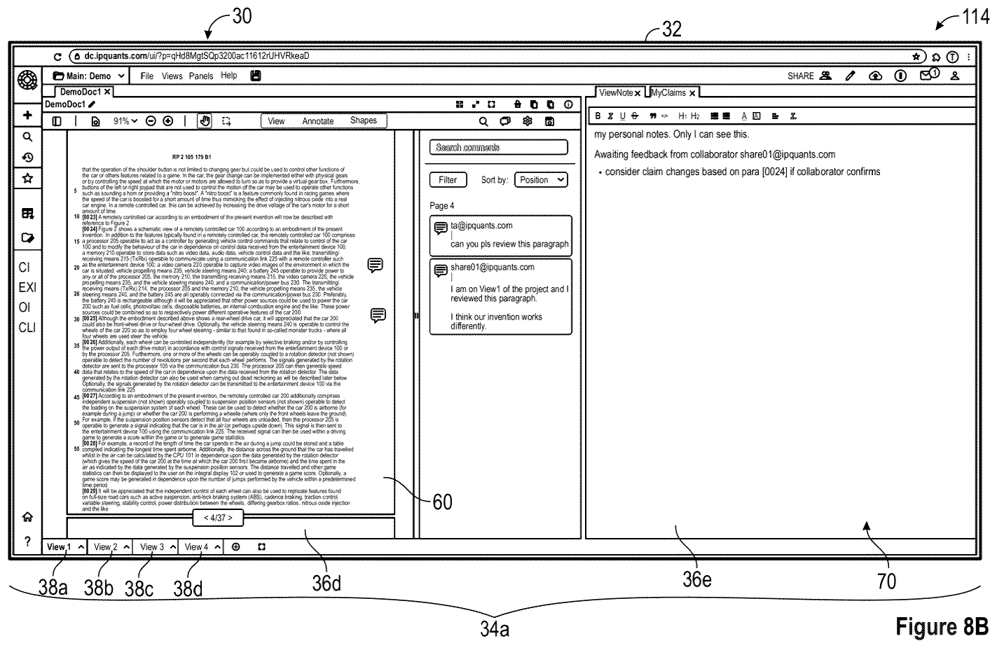

FIG. 8a illustrates a screen shot 112 of the user interface 32a for the collaborator. The user interface 32a having a project view 34a including the project content section 36a shared with the collaborator share01@ipquants.com. The project content section 36a includes a document 60 having a plurality of annotations 62a. Annotations 62a may be provided by the project owner and/or one or more of the collaborators. An annotation window 64 may provide textual comment section boxes 62b of the annotations 62a. Additions of annotations are synchronized across all project content sections 36a within the electronic project 30.

FIG. 8b illustrates a screen shot 114 of the user interface 32 for the project owner. The user interface 32 having the electronic project 30 with the project view 34a including the project content section 36d. As described herein, the project owner has access to all project views 34 via the project view tabs 38a-38d. To that end, the project owner is able to view the same document 60 as the collaborator (shown in FIG. 8a). It should be noted that the project owner is viewing the same document 60 as the collaborator, but in a different project view 34a and accessible via project view tab 38b. Thus, the user interface 32 of the project owner can be arranged with one or more project content sections 36 in one or more project views 34. In the project view 34a, the user interface 32 includes the project content section 36d having document 60. Additionally, the project view 34a includes the project content section 36e having a notation system 70. The notation system 70 provides for personal notes capable of being shared with and/or between the one or more collaborator(s). Notations within the notation system 70 may be synchronized across the project content section 36e within the electronic project 30.

Referring to FIGS. 8a and 8b, the user interface 32a having the project view 34a with project content sections 36d and 36e provides the project owner with side-by-side arrangement of document 60 and notation system 70. The user interface 32 having the project view 34 with project content section 36a provides the collaborator with the document 60, viewing the same document as the project owner. Thus, the project owner is able to maintain preferred content arrangement, despite sharing portions of the electronic project 30 with the one or more collaborators.

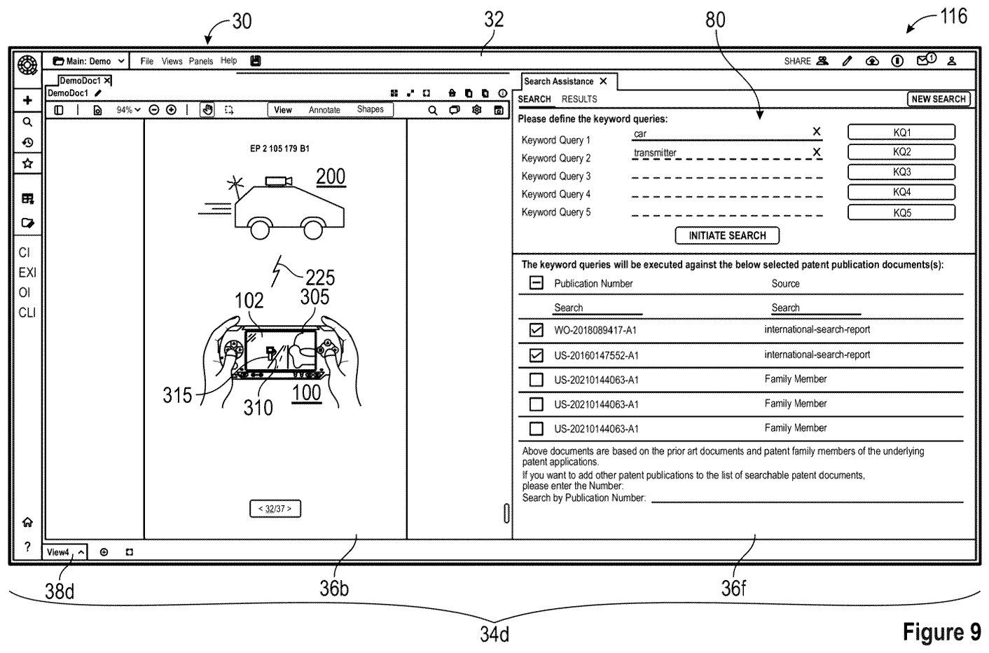

FIG. 9 is a screen shot 116 of the user interface 32 of the project owner. The user interface 32 having the electronic project 30 with the project view 34d accessible via the project viewing tab 38d. The project view 34d includes a first project content section 36b and a second project content section 36f. The first project content section 36b includes a PDF document. The second project content section 36f includes a search interface system 80. The search interface system 80 is configured to provide one or more keyword search queries. By including multiple functional options for project content section 36 within each project view 34, the single user interface 32 may be used. In some embodiments, the project owner configures each project content section 36 for each project view 34.

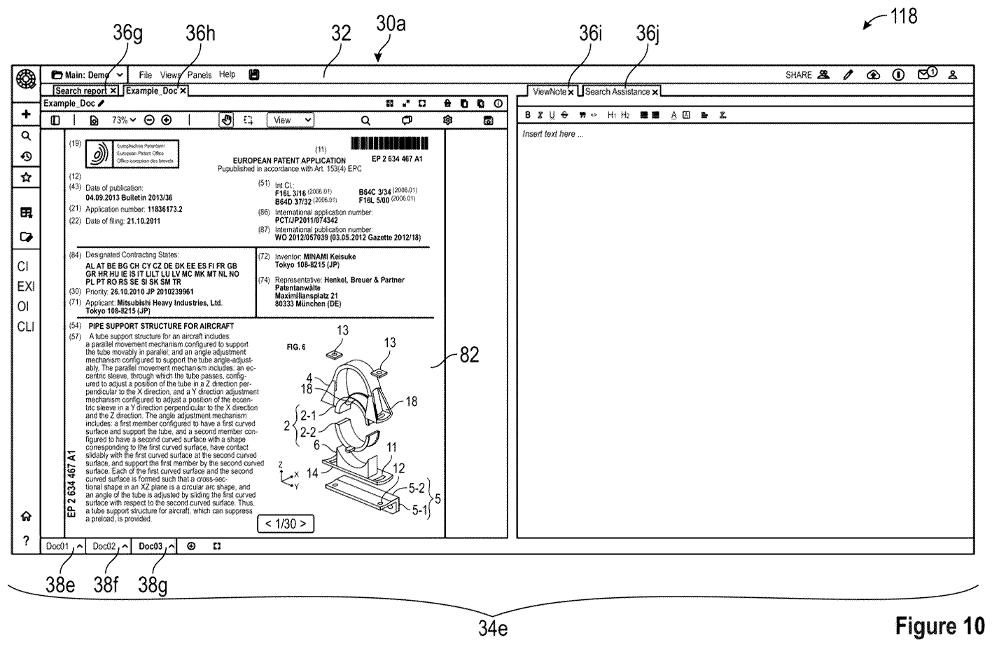

FIG. 10 is a screen shot 118 of the user interface 32 for the project owner. The user interface 32 includes the electronic project 30a loaded within a browser tab. The electronic project 30a includes three project views 34 accessible by the project viewing tabs 38e, 38f, and 38g. Shown in FIG. 10 is the project view 34e. The project view 34e includes four project content sections 36g, 36h, 36i, 36j. Each project content section 36g-36j includes a panel that is configured to be re-sizable, re-arrangeable, and/or restackable. Additionally, each panel of the project content section 36 can be added to the project view 34e. For example, the project content sections 36 are stacked in FIG. 10. Each project content section 36g-36j may be configured to load and/or display content (e.g., text document, HTML page, and/or the like). Each project content section 36g-36j may be configured to display audio and/or video. Additionally, each project content section 36g-36j may be configured to display audio and/or video in addition to a text based document or independent thereof.

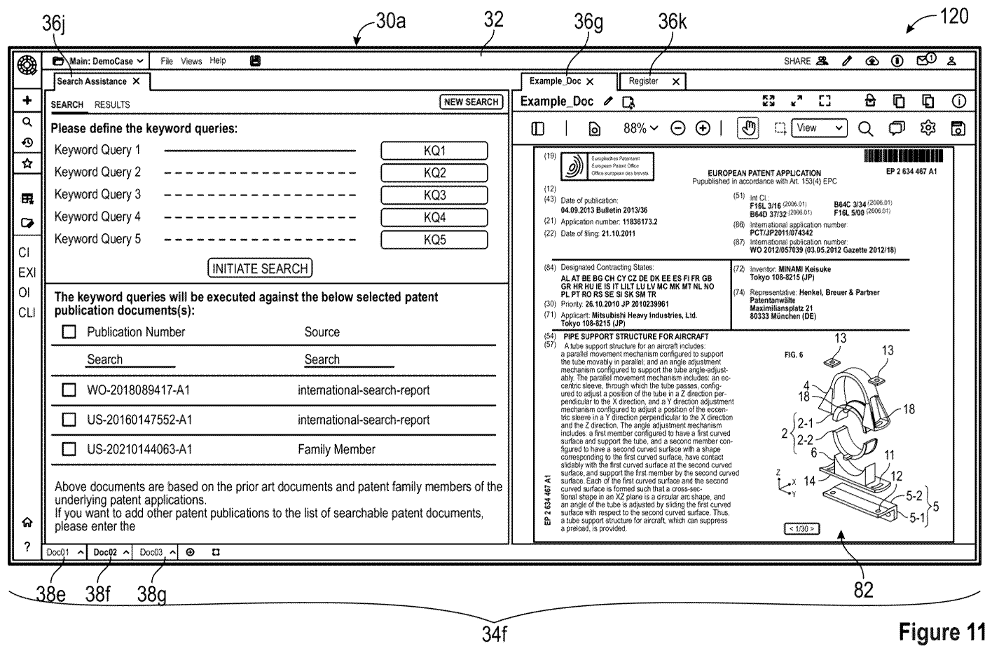

Different project views 34 may include different project content sections 36 arranged in different configurations while loading and displaying the same content. The project view 34e shown in FIG. 10, includes project content section 36h arranged side-by-side with project content section 36i. Within project content section 36h is the PDF document Example_Doc 82. FIG. 11 is a screen shot 120 of the user interface 32 having the electronic project 30a illustrating project view 34f accessible via the project view tab 38f. The project view 34f includes the project content section 36g having the PDF document 82 arranged in a different manner than shown in FIG. 10. Annotations and/or comments provided within the project content section 36g will remain with project content section 36g. That is, annotations and/or comments may be configured to synchronize across all project views 34, including project views 34 hidden and/or inaccessible to one or more collaborators. The project owner is able to provide the project content section 36g, for example, receive annotations and/or comments from collaborators regarding the document 82 within the project content section 36g, and such comments and/or annotations may be synced to the project content section 36g within additional project views 34 not-shared with one or more collaborators.

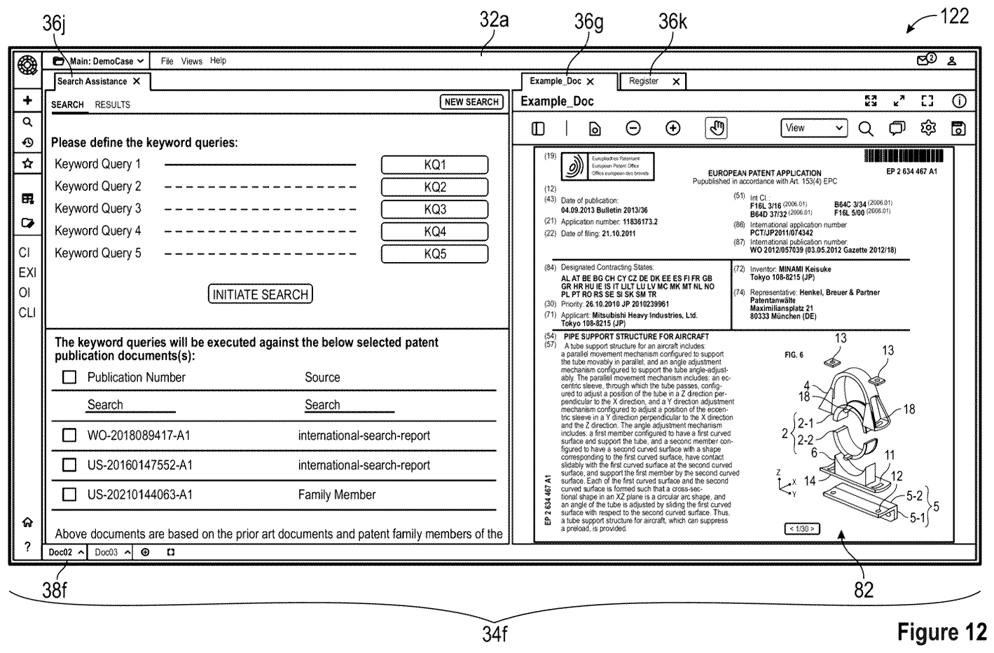

FIG. 12 is a screen shot 122 of the user interface 32a for the collaborator based on configuration of the electronic project 30a provided by the project owner. The electronic project 30a in the view provided to the collaborator solely includes project view 34f accessible via the single project view tab 38f. The project view 34f includes the project content section 36g having the PDF document 82 arranged in a similar manner as in FIG. 11.

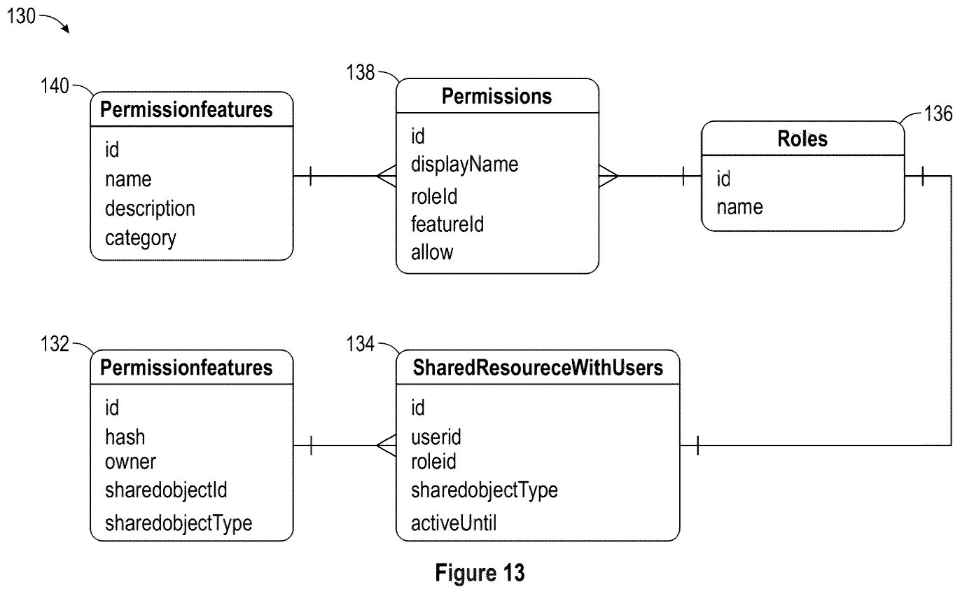

FIG. 13 is a block diagram 130 illustrating exemplary logic schematics of the database 22 shown in FIG. 1. Generally, sharing setting and/or permission settings may be stored and implemented as described in further detail herein. Each electronic project may be assigned a first unique identifier (UID) within the database 22. Additionally, each project view may be assigned a second UID within the database 22. Further, each project content section 36 may be assigned a third UID within the database 22.

The electronic project 30 associated project views 34 and associated project content sections 36 may be selected to be shared. Each UID of each element to be shared may be copied into a field defined as sharedObjectID. For example, if the UID of the electronic project is UID=001, then the value of the sharedObjectID may be set to 001 providing a key between the SharedResources table 132 and a general database table.

Each element selected to be shared may be stored in the SharedResources table 132 and assigned an identifier (i.e., SharedResourcesID). For example, the electronic project 30 having the UID 001 and a corresponding sharedObjectID 001 may be assigned a SharedResourcesID 45678.

Each element in the SharedResources table 132 may further have owner info defined and the sharedObjectType information defined. The SharedObjectType information is a string describing the shared resource (e.g., Project View if the shared resource is a project view 34).

In addition, the SharedResources table 132 may be linked with a SharedResourceWithUsers table 134 that enables to link the SharedResourcesID with userid and user roleid. Each shared project element, such as the project view 34, thus has a SharedResourceID as defined in table 132 and the value also copied to table 134.

The SharedResourceWithUsers table 134 defines an identification (i.e., id) providing a unique identifier for each combination of user, role, and shared resource. The Role ID within the SharedResourceWithUsers table 134 refers to the type of collaborator role, such as Viewer or Can Comment collaborator. The Viewer collaborator only has the right to view content and cannot make any annotations or edits in the shared resources, while the Can Comment role gives the collaborator certain permissions to alter the content of the shared resource. Additional user roles are contemplated allowing for editing and/or manipulating of the project content sections 36.

The RoleID within the SharedResourceWithUsers table 134 links the tables SharedResourceWithUsers and Roles table 136. For each user role, specific permission settings may be defined via the Permission table 138. A permission ID may be defined for each element in the project, such as UI buttons, drop-down menus, annotation tools, icons. The permission settings may be defined by the PermissionFeatures table 140 to allow control on whether a user is allowed to interact with one or more feature. The permission settings can be tied to the user roleID. For example, certain UI buttons may be hidden from a user with a roleID “Viewer”, such as the buttons to add an annotation, while a user with roleID “CanComment” will be able to interact with such a button. The Permissions table 138 and PermissionFeatures table 140 enable a flexible definition of permissions to access features of the project based on the different user types based on the different user role types.

By implementing such database logic a sharing operation of the synchronization system 10 shown in FIG. 1 and as defined within the description and figures is enabled. This provides the key benefit that if a resource is not selected to be shared, the object is not sent to the user from the database 22. In other words, no content is sent from the database 22 to the client side. Hence, when the view is not rendered in the browser of the collaborator and the associated view tab not displayed, there is also no other indication client side, such as in the metadata, that a non-shared resource exists. The collaborator that receives access to a project only gets access to the resources defined by the owner as shared resources as defined and stored in the tables as shown in FIG. 13.

It should be noted that any computer hardware/software architecture may be utilised to implement an embodiment of the present disclosure. The disclosure is not limited to implementation by the type of computer architecture illustrated and described in relation to FIG. 1. For example, other arrangements such as central mainframe/terminal architecture, client/server architecture or any other type of arrangement may be utilised to implement the present disclosure, such as cloud computing or a mix of the mentioned computer architecture. In one arrangement, a plurality of network computers may be utilised to enable, for example, a plurality of users to access the system from their own computer terminals. The network may be any network, the Internet for example.

What is claimed is:

1. A method, comprising:
displaying on a user interface an electronic project having a first project view containing a first project content section and a second project view containing a second project content section, each of the first project view and second project view is accessible via the user interface;
sharing the electronic project with at least one collaborator via a collaborator interface; and,
displaying the electronic project on the collaborator interface such that the first project view is accessible via the collaborator interface and the second project view is inaccessible via the collaborator interface.

2. The method of claim 1, wherein the first project view contains the first project content section and a third project content section.

3. The method of claim 2, wherein the third project content section is accessible via the user interface and inaccessible via the collaborator interface.

4. The method of claim 1, wherein the first project view is rendered in a browser window.

5. The method of claim 1, wherein the first project view is rendered in a desktop user interface.

6. The method of claim 1, wherein the first project view includes the first project content section rendered as a first user interface panel and a third project content section rendered as a second user interface panel.

7. The method of claim 6, wherein the first user interface panel and the second user interface panel are configured to be re-arrangeable and re-sizeable within the first project view.

8. The method of claim 6, wherein the first project content section is configured to provide at least one textual document for viewing.

9. The method of claim 6, wherein the first project content section is configured to provide at least one productivity enhancing tool.

10. The method of claim 9, wherein the at least one productivity enhancing tool is a search engine.

11. The method of claim 6, wherein the first project content section is configured to provide data in textual format.

12. The method of claim 1, further comprising the step of assigning a first collaborator right to at least one collaborator, wherein the second project view is inaccessible via the collaborator interface based on the first collaborator right.

13. The method of claim 1, wherein the first project view includes the first project content section and a third project content section, and wherein the method further comprises the step of assigning a first collaborator right and a second collaborator right to at least one collaborator, wherein the first collaborator right defines editing rights on the first project view for the at least one collaborator and the second collaborator right defines viewing rights on the second project view for the at least one collaborator.

14. The method of claim 1, wherein the first project view includes the first project content section and a third project content section, and wherein the method further comprises the step of assigning a first collaborator right to at least one collaborator, wherein the first collaborator right defines editing rights on the first project content section for the at least one collaborator.

15. The method of claim 14, further comprising the step of assigning a second collaborator right to the at least one collaborator, wherein the second collaborator right defines viewing rights to the second project content section.

16. The method of claim 1, further comprising the steps of:
displaying the first project section of the electronic project in the first project view within the user interface, the first project section displaying a first content to the project owner;
display the second project section of the electronic project in the second project view on the user interface, the second project section displaying the first content to at least the project owner,
synchronize the first content between the first project section and the second project section.

17. A computing system for reviewing an electronic project by at least one project owner, the computing system comprising:
a processor; and
a non-transitory computer readable medium in communication with the processor, the non-transitory computer readable medium storing computer executable instructions that when executed by the processor cause the processor to:
provide first signals over a communication network to cause at least a first project section of the electronic project to be displayed in a first project view on a first user interface, the first project section displaying a first content to the at least one the project owner;
provide second signals over a communication network to cause at least a second project section of the electronic project to be displayed in a second project view on the first user interface; and,
provide third signals over the communication network to cause the electronic project to be shared with at least one collaborator on a collaborator interface;
wherein the third signals cause the first project view of the electronic project to be displayed on the collaborator interface such that the second project view is inaccessible to the collaborator interface.

18. The computing system of claim 17, wherein the third signals provide solely for the first project view of the electronic project to be displayed based on at least one stored permission setting.

19. The computing system of claim 18, wherein a second stored permission setting enables the collaborator to alter content of the first project view of the electronic project.

20. A method for reviewing an electronic project by at least one project owner, the method comprising the steps of:
displaying at least a first project section of the electronic project in a project view, the first project section displays a first content to at least the project owner;
displaying at least a second project section of the electronic project in the project view;
controlling sharing permissions such that the collaborator is only shown one of the first and second project sections,
sharing the electronic project comprising the project view with at least one collaborator; and,
displaying to the collaborator only one of the first and second project sections of the shared project view such that the collaborator is not aware of existence of the non-shared project section of the project view.
